(19) United States
(12) Patent Application Publication
(10) Pub. No.: US 2014/0324988 A1
(43) Pub. Date: Oct. 30, 2014

(54) METHOD AND APPARATUS FOR OBTAINING GEOGRAPHIC LOCATION INFORMATION OF A PRIVATE USER IN INSTANT MESSAGING

(71) Applicant: Xiao Long Zhang, Shenzhen (CN)

(72) Inventor: Xiao Long Zhang, Shenzhen (CN)

(21) Appl. No.: 13/993,605

(22) PCT Filed: Apr. 27, 2013
(86) PCT No.: PCT/CN13/74898

§ 371 Date: Jun. 12, 2013

(51) Int. Cl. H04L 12/58

(52) U.S. Cl. CPC H04L 51/04
USPC 709/206

(57) ABSTRACT

In a method for obtaining geographic location information of a private user in instant messaging, when a conversation window between the private user and a public account is opened, determining, by a client device of the private user, whether the private user allows the public account to acquire geographic location information of the private user; obtaining and transmitting, by the client device of the private user, the geographic location information of the private user to an IM server if the private user allows the public account to acquire the geographic location information of the private user, such that the IM server provides the geographic location information of the private user to the public account.

### FIELD

The present disclosure relates to instant messaging techniques, and more specifically, to a method and an apparatus for obtaining geographic location information of a private user in instant messaging.

### BACKGROUND

Instant Messaging (IM) is a form of communication over the Internet that offers quick transmission of messages from sender to receiver. It may address point-to-point communications as well as multicast communications from one sender to many receivers.

More advanced instant messaging allows enhanced modes of communication, such as live voice or video calling, video chat and inclusion of hyperlink to media.

At present, some instant messaging provides a public platform for users. Companies, brands and celebrities may register on the public platform to have a public account (or referred to as official account) to communicate with their customers and fans directly. For example, WeChat (Weixin) has released a public platform for users to register public account. After registering on the public platform, the user gets a public account. Through the public platform of WeChat, venders may sell stuff or send news update, discount voucher, campaign announcement to their customers (also referred to as private users) on WeChat. And customers (private users) may receive messages such as “wait”, “hold on a second”, “in this way” from venders.

### SUMMARY

Various examples of the present disclosure provide a method and an apparatus for obtaining geographic location information of a private user in instant messaging.

According to one example of the present disclosure, a computer-implemented method for obtaining geographic location information of a private user in instant messaging includes:

when a conversation window between the private user and a public account is opened on a client device of the private user, determining, by the client device of the private user, whether the private user allows the public account to acquire geographic location information of the private user;

obtaining and transmitting, by the client device of the private user, the geographic location information of the private user to an IM server if the private user allows the public account to acquire the geographic location information of the private user, such that the IM server provides the geographic location information of the private user to the public account.

According to another example of the present disclosure, a computer-implemented method for obtaining geographic location information of a private user in instant messaging includes:

receiving, by an IM server, geographic location information of a private user, wherein when a conversation window is opened between the private user and a public user and if the private user allows the public user to acquire the geographic location information of the private user, the geographic location information of the private user is transmitted by a client device of the private user to the IM server; and

providing, by the IM server, the geographic location information of the private user to the public user.

According to another example of the present disclosure, a client device of a private user in instant messaging includes a processor and a memory coupled to the processor, wherein the memory comprises machine readable instructions executable by the processor to:

determine whether a private user allows a public account to acquire geographic location information of the private user when a conversation window between the private user and the public account is opened;

obtain the geographic location information of the private user if the private user allows the public account to acquire the geographic location information of the private user; and

transmit the geographic location information of the private user to an IM server, such that the IM server provides the geographic location information of the private user to the public account.

According to another example of the present disclosure, an IM server includes a processor and a memory coupled to the processor, wherein the memory comprises machine readable instructions executable by the processor to:

receive geographic location information of a private user, wherein when a conversation window is opened between the private user and a public user and if the private user allows the public user to acquire the geographic location information of the private user, the geographic location information of the private user is transmitted by a client device of the private user to the IM server; and provide the geographic location information of the private user to the public user.

According to another example of the present disclosure, a non-transitory computer readable storage medium storing one or more programs, which when executed by a processor, perform the steps of:

determining whether a private user allows a public account to acquire geographic location information of the private user when a conversation window between the private user and the public account is opened;

obtaining the geographic location information of the private user if the private user allows the public account to acquire the geographic location information of the private user; and

transmitting the geographic location information of the private user to an IM server, such that the IM server provides the geographic location information of the private user to the public account.

According to another example of the present disclosure, a non-transitory computer readable storage medium storing one or more programs, which when executed by a processor, perform the steps of:

receiving geographic location information of a private user, wherein when a conversation window is opened between the private user and a public user and if the private user allows the public user to acquire the geographic location information of the private user, the geographic location information of the private user is transmitted by a client device of the private user; and

providing the geographic location information of the private user to the public user.

The method and apparatus provided by various examples of the present disclosure beneficially allows a public account to acquire the geographic location information. Thus, the public account may provide services to the private user according to the geographic location of the private user. The public account may provide a better service and the experience of the private user is improved.

The features and advantages described in the disclosure are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating a network computer system 100 for obtaining geographic location information of a private user in accordance with an example of the present disclosure.

FIG. 2 is a block diagram illustrating a method for obtaining geographic location information of a private user in accordance with an example of the present disclosure.

FIG. 3A is a block diagram illustrating another method for obtaining geographic location information of a private user in accordance with an example of the present disclosure.

FIG. 3B is a block diagram illustrating a method for obtaining geographic location information of a private user in accordance with an example of the present disclosure.

FIG. 4 is a flowchart illustrating a server 160 for obtaining geographic location information of a private user in accordance with an example of the present disclosure.

FIG. 5 is a schematic diagram illustrating a smartphone 110 for obtaining geographic location information of a private user in accordance with an example of the present disclosure.

FIG. 6 is a block diagram illustrating a message for transmitting geographic location information of a private user in accordance with an example of the present disclosure.

### DETAILED DESCRIPTION

Hereinafter, the present disclosure will be described in further detail with reference to the accompanying drawings and examples to make the technical solution and merits therein clearer.

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

Aspects of the present disclosure are described herein with reference to flowchart illustrations and/or block diagrams of method, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable processing apparatus or other devices to produce a computer implemented process such that the instructions which execute on the computer or other programmable apparatus provided processes for implementing the functions/acts specified in the flowchart and/or block diagram block or blocks.

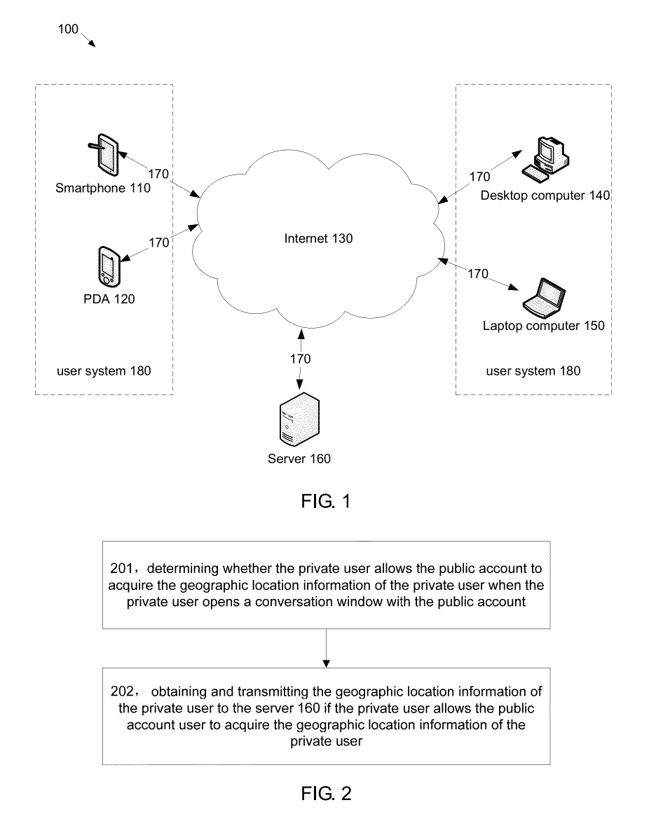

Referring now to FIG. 1, a network computer system 100 for obtaining geographic location information of a private user in instant messaging in accordance with an example of the present disclosure comprises: a server 160; a user system 180; and the Internet 130. The user system 180 may include one or more client devices such as a smartphone 110, a Personal Digital Assistant 120, a desktop computer 140 and a laptop computer 150. Additionally, other devices such as netbooks, handheld and palmtop devices are also included in the description of client devices that may be deployed as a client device in user system 180.

All of the client devices in the user system 180 are connected or coupled via a link 170 to the Internet 130.

Smartphone 110, PDA 120, desktop computer 140 and laptop computer 150 include communication software to enable users to access the server 160. Typically, users of smartphone 110 and PDA 120 access the server 160 using an IM client application installed in the smartphone 110 and PDA 120. Users of the desktop computer 140 and laptop computer 150 may access the server 160 using an IM public platform provided by the server 160.

In various examples of the present disclosure, users accessing the server 160 using the IM client application installed in the client device may be referred to as private users. Users accessing the server 160 using an IM public platform provided by the server 160 may be referred to as public users or public accounts.

The server 160 may support IM services, i.e., allow users to send and receive IM messages. The server 160 may support other services related to IM.

To begin an IM session, a user may access the server 160 using an IM client application (for private users) or log on an IM public platform (for public users) and then exchanges IM messages with the particular buddies or participates in a group chat.

Link 170 represents any suitable communication link or similar communication mechanism including some combination of a hardwired connection, an internal or external bus, a connection for telephone access via radio, infrared or other wireless communication methodologies (i.e., “Wi-Fi” or “Wi-max”, “Bluetooth”, infrared, etc.), private or proprietary local area networks (LANs) and wide area networks (WANs), as well as standard computer network communications over Internet 130 or an internal network (e.g., “intranet”) via a wired or wireless connection, or any other suitable connection between computers and computer components known to those skilled in the art, whether currently known or developed in the future.

In addition to the other components shown in FIG. 1, a wireless communication access device may be communicatively coupled to link 170 and may be any wireless communication mechanism that is known to those skilled in the art to provide wireless communication between the Internet 130 and various devices associated with the Internet 130, including smartphone 110, PDA 120, desktop computer 140 as well as laptop computer 150. In various examples of the present disclosure, an acceptable wireless communication access device may comprise any type of wireless access point, wireless bridge, wireless router, or similar type of device (no shown in FIG. 1).

Server 160 in FIG. 1 represents a computer system that is made available to the client devices in the user system 180 via link 170 and the Internet 130. Various hardware components (not shown in FIG. 1) such as external monitors, keyboards, mice, tablets, hard disk drives, magnetic tapes, and other devices may be used in conjunction with server 160.

The server 160 may include a user profile server (not shown) connected to a database (not shown) for storing large amounts of user profile data. The user profile server may be used to enter, retrieve, edit, manipulate or otherwise process user profile data. In one implementation, a user's profile data includes, for example, user name, buddy list, geographic location, interests, etc. Users may enter, edit and/or delete profile data using the installed IM client application or through the public platform.

Server 160 may also provide various additional software components (not shown in FIG. 1) such as database servers, web servers, firewalls, security software, and the like. The use of these various hardware and software components is well known to those skilled in the art. In at least one preferred example, the server 160 is used to offer a “public platform” and other IM services.

Smartphone 110 and PDA 120 in the user system 180 are representatives of any type of cellular device or telephone that may be communicatively coupled to network computer system 100.

Desktop computer 140 in the user system 180 may be any type of computer system known to those skilled in the art that is capable of being configured for use with network computer system 100 as described herein. As previously explained in conjunction with server 160, various hardware components and software components (not shown in FIG. 1) known to those skilled in the art may be used in conjunction with desktop computer 140.

Similarly, laptop computer 150 in the user system 180 may be any type of portable computer system known to those skilled in the art that is capable of being configured for use with network computer system 100 as described herein.

In general, users of desktop computer 140 and laptop computer 150 may log on a “public platform” provided by the server 160 so as to receive IM services provided by the server 160. It should be noted that, public users may also access the Internet 130 via devices such as smartphone 110 and PDA 120, but not restricted to use the desktop computer 140 or laptop computer 150.

In various examples of the present disclosure, users of smartphone 110 and PDA 120 may access the Internet 130 via an IM application installed in the smartphone 110 and PDA 120. It should be noted that, private users may also access the Internet via the IM applications installed in devices such as desktop computer 140 or laptop computer 150.

Hereinafter, the method provided by various examples of the present disclosure will be described more fully with reference to the network computer system 100.

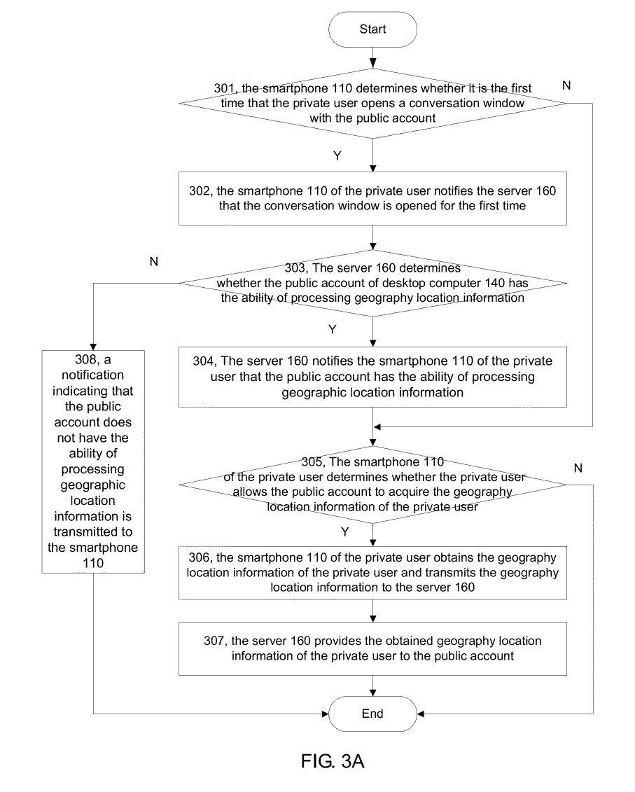

Referring now to FIG. 2, a block diagram of obtaining geographic location information of a private user in instant messaging in accordance with an example of the present disclosure is depicted. The procedure of FIG. 2 may be implemented by various types of hardware, software, device, computer, computer system, equipment, component, program, application, code, storage medium, or propagated signal.

The method shown in FIG. 2 involves determining whether the private user allows the public account to acquire the geographic location information of the private user when the private user opens a conversation window with the public account (block 201) and obtaining and transmitting the geographic location information of the private user to the server 160 if the private user allows the public account user to acquire the geographic location information of the private user (block 202).

Hereinafter, the procedure of FIG. 2 will be described more fully with reference to several examples and the accompanying drawings.

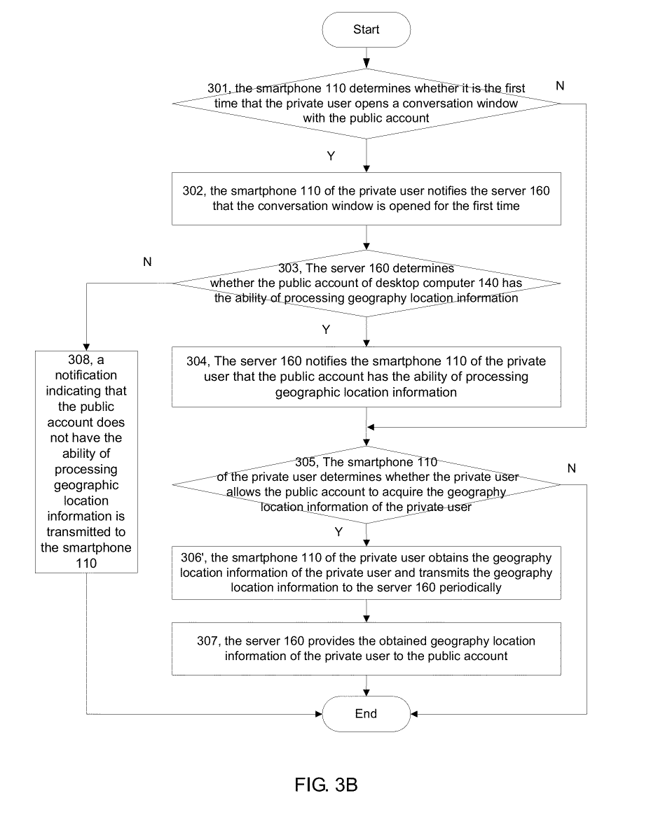

FIG. 3A is a schematic diagram illustrating a method for obtaining geographic location information of a private user in instant messaging in accordance with an example of the present disclosure. It should be noted that some functions of the procedure shown in FIG. 3A are not necessarily essential for implementing the present disclosure.

As shown in FIG. 3A, a private user will communicate with network computer system 100 shown in FIG. 1. Hereinafter, the user of smartphone 110 is taken as an exemplary private user, and the user of desktop computer 140 is taken as an exemplary public user (i.e., public account). In one implementation, the server 160 may be a WeChat server. It should be noted that, the method is also applicable for other instant messaging tools.

As shown in FIG. 3A, the method includes the following operations.

At block 301, when the private user of smartphone 110 opens a conversation window with the public account of desktop computer 140, the smartphone 110 determines whether it is the first time that the private user opens a conversation window with the public account. If it is the first time that the private user opens the conversation window with the public account, block 302 is performed; otherwise, block 305 is performed.

In this block, the private user of the smartphone 110 opens the conversation window with the public account for the first time means that the private user has not opened a conversation window between the private user and the public account before. In one implementation, the private user may open the conversation window with the public account when the private user desires to chat with the public account. Or, the private user may open the conversation window with the public account after receiving a broadcast message from the public account.

In one implementation, when the private user adds the public account into a buddy list of the private user, the smartphone 110 of the private user may record a user name (or user ID) of the public account. In addition, an identifier used for indicating whether a conversation window between the public account and the private user has once been opened may be configured in association with the user name (or user ID) of the public account.

For example, the value “0” of the identifier may be used for indicating that there is no conversation window has once been opened between the private user and the public account, whereas the value “1” of the identifier may be used for indicating that there is a conversation window has once been opened. In one implementation, the value “0” of the identifier may be set as a default value. Therefore, when the private user adds the public account into the buddy list, the default value “0” is set for the identifier.

Once a conversation window between the private user and the public account is opened, the smartphone 110 changes the value of the identifier to “1”. Thus, in this block, the smartphone 110 may determine whether the conversation window is opened for the first time according to the value of the identifier. In particular, if the value of the identifier is “1”, it means that the conversation window has once been opened, i.e., is not opened for the first time. If the value of the identifier is “0”, it means that the conversation window is opened for the first time.

It should be noted that the above is merely an example of the present disclosure. Those skilled in the art may determine whether conversation window is opened for the first time through other manners which are also within the protection scope of the present disclosure.

At block 302, the smartphone 110 of the private user notifies the server 160 that the conversation window between the private user and the public account is opened for the first time.

In one implementation, the smartphone 110 may transmit a first message to the server 160 notifying the server 160 that the conversation window between the private user and the public account is opened for the first time.

The first message may include a message type, a private user ID, a public user ID and message content, wherein the message content is used for notifying the server 160 that the conversation window between the private user and the public account is opened for the first time. In this example, the private user ID is the ID of the private user of the smartphone 110, and the public user ID is the ID of the public account of desktop computer 140. It should be noted that the first message may further include other elements which are not restricted in the present disclosure.

At block 303, the server 160 determines whether the public account of desktop computer 140 has the ability of processing geographic location information. If the public account has the ability of processing geographic location information, block 304 is performed; otherwise, a notification indicating that the public account does not have the ability of processing geographic location information is transmitted to the smartphone 110 at block 308 and then the method ends.

In one implementation, after receiving the first message, the server 160 may analyze the message content of the first message and knows that the conversation window between the private user and the public user identified by the private user ID and the public user ID in the first message is opened for the first time. Then, the server 160 determines whether the public account of desktop computer 140 has the ability of processing geographic location information.

The ability of processing geographic location information means that the public account is capable of sending corresponding messages or providing particular services to the private user in response to the geographic location information of the private user. In this example, the public user may indicate whether he has this ability when he registers on the server 160 through the public platform. In one implementation, information indicating whether the public account has the ability of processing geographic location information may be recorded in profile data of the public account in the server 160. Thus, the server 160 may determine whether the public account has the ability of processing geographic location information according to the profile data of the public account.

At block 304, the server 160 notifies the smartphone 110 of the private user that the public account has the ability of processing geographic location information.

In one implementation, the server 160 may generate and transmit a second message to the smartphone 110 of the private user, notifying the private user that the public account has the ability of processing geographic location information. The second message may include a message type, a private user ID, a public user ID and message content. In this example, the private user ID is the ID of the private user of smartphone 110 and the public user ID is the ID of the public account of desktop computer 140. It should be noted that not all the elements are mandatory and second message may further include other elements.

At block 305, the smartphone 110 of the private user determines whether the private user allows the public account to acquire geographic location information of the private user. If the private user allows the public account to acquire the geographic location information of the private user, block 306 is performed; otherwise, the method ends.

In one implementation, if it is the first time that the private user opens the conversation window with the public account, the smartphone 110 may display, after receiving the second message from the server 160, a prompt window to the private user asking the private user whether he allows the public account to acquire the geographic location information of the private user. Typically, the prompt window may include two buttons “allow” and “not allow”. Once the private user clicks a button, the smartphone 110 may know whether the private user allows the public account to acquire the geographic location information or not.

After the private user clicks the button in the prompt window, the smartphone 110 of the private user may record a status of authorization in the smartphone 110. In one example, the status of authorization may be recorded in association with the ID of the public account. The status of authorization indicates whether the private user allows the public account to acquire the geographic location information of the private user. And the status of authorization may include allow and forbid.

Thereafter, when the private user opens a conversation window with the public account for a next time, the smartphone 110 may determine whether the private user allows the public account to acquire the geographic location information of the private user according to the recorded status of authorization.

In one implementation, if it is not the first time that the private user opens the conversation window with the public account, the smartphone 110 of the private user may determine whether the private user allows the public user to acquire his geographic location information according to the recorded status of authorization, and may automatically obtain and report the geographic location information of the private user if the status of authorization indicates that the private user allows the public account to acquire the geographic location information of the private user.

At block 306, the smartphone 110 of the private user obtains the geographic location information of the private user and transmits the geographic location information to the server 160.

In various examples of the present disclosure, the geographic location information may be longitude and latitude information, or an IP address, or an address (such as name of a building) of the private user.

There may be several manners for the smartphone 110 to obtain the geographic location information of the private user.

In a first manner, the smartphone 110 may obtain the geographic location information of the private user using Wi-Fi. In this manner, the obtained geographic location information may be an IP address of the private user. In this case, the IP address may be converted into longitude and latitude information. The detailed conversion procedure is known for those skilled in the art and will not be repeated herein. In a second manner, the smartphone 110 may obtain the geographic location information of the private user through a base station of a cellular network. In a third manner, the smartphone 110 may obtain the geographic location information of the private user through Global Positioning System (GPS).

Detailed processes of obtaining the geographic location information according to the above manners are well known for those skilled in the art and will not be repeated herein.

Preferably, the smartphone 110 may obtain the geographic location information of the private user using Wi-Fi. If Wi-Fi is not available, the geographic location information of the private user may be obtained using the cellular base station, i.e., the manner of obtaining through a base station is less preferable. In one implementation, the manner of GPS is the least preferable.

At block 307, the server 160 provides the obtained geographic location information of the private user to the public account.

Thereinafter, the public account may return a message or providing a corresponding service to the private user according to the geographic location information of the private user.

For example, if the public account determines that the private user is near to a shop of the public account, the public account may transmit a discount voucher to the private user.

In block 306 in FIG. 3A, the geographic location information is obtained and transmitted to the server 160 for one time when the conversation window is opened. In another implementation, the geographic location information may be obtained and transmitted periodically after the conversation window is opened.

FIG. 3B is a flowchart illustrating a method for obtaining geographic location information of a private user in instant messaging in accordance with an example of the present disclosure.

In FIG. 3B, blocks 301 to 305 and 307 to 308 are the same with corresponding blocks in FIG. 3A, thus will not be repeated herein.

At block 306′ in FIG. 3B, after determining that the private user allows the public account to acquire the geographic location information of the private user, the smartphone 110 of the private user obtains the geographic location information of the private user and transmits the geographic location information to the server 160 periodically. In one implementation, the time interval may be configured by the private user on the smartphone 110, e.g., 5 minutes. Thus, the smartphone obtains the geographic location information of the private user and transmits the geographic location information to the server 160 every 5 minutes after the conversation window is opened. Thus, if the private user moves during the conversation, the public account may provide accurate information to the private user according to the geographic location of the private user.

The detailed method for obtaining the geographic location information of the private user in block 306′ in FIG. 3B is the same as those described above in block 306 in FIG. 3A.

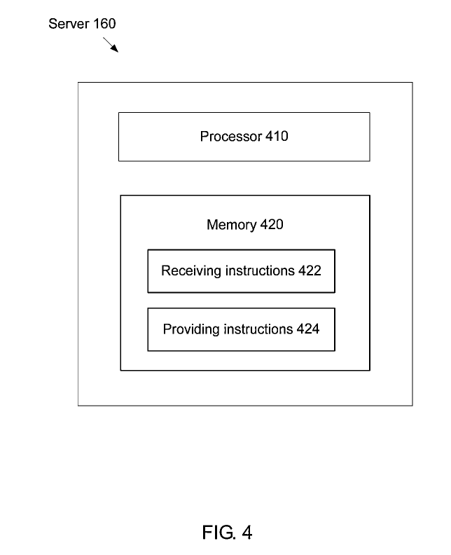

In accordance with the above method, various examples of the present disclosure further provide a server 160 for obtaining geographic location information of a private user in instant messaging. FIG. 4 is a schematic diagram illustrating a server 160 for obtaining geographic location information of a private user in instant messaging in accordance with an example of the present disclosure.

As shown in FIG. 4, the server 160 may include at least one Central Processing Unit (CPU) or a processor 410 and a memory 420. Note that the server 160 may further include a network interface, a display interface and so on. Various modifications, additions or deletions may be made to the server 160 illustrated in FIG. 4 within the scope of the present disclosure.

Processor 410 performs computation and control functions of server 160. Processor 410 may include a single integrated circuit, such as a microprocessor, or may include any suitable number of integrated circuit devices and/or circuit boards working in cooperation to accomplish the functions of a processor or a CPU. The processor 410 is configured to execute one or more software programs contained in the memory 420.

The memory 420 includes:

receiving instructions 422, for receiving geographic location information of a private user, wherein the geographic location information of the private user is transmitted by a client device of the private user when a conversation window is opened between the private user and a public user and if the private user allows the public user to acquire the geographic location information of the private user; and

providing instructions 424, for providing the geographic location information of the private user to the public user.

The memory 420 may further include instructions for receiving from the client device of the private user a message indicating that the conversation window between the private user and the public account is opened for a first time; and determining whether the public account has an ability of processing geographic location information and notifying a determined result to client device of the private user.

The memory 420 may store data and programs such as an operating system and one or more application programs.

Detailed functions of the server 160 have been described above with reference to the procedure as shown in FIG. 2, FIG. 3A and FIG. 3B and will not be repeated herein.

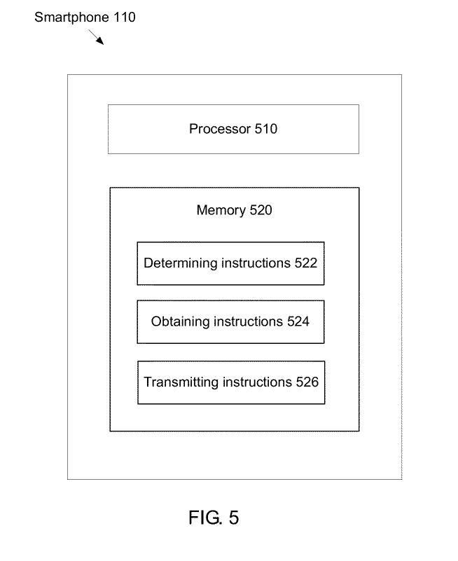

FIG. 5 is a schematic diagram illustrating a client apparatus for obtaining geographic location information of a private user in instant message in accordance with an example of the present disclosure. Hereinafter, the smartphone 110 is taken as an exemplary client apparatus. As shown in FIG. 5, the smartphone 110 includes at least one CPU or a processor 510 and a memory 520. Note that the smartphone 110 may further include an input/output interface, a network interface, a display interface and so on. Various modifications, additions or deletions may be made to the smartphone 110 illustrated in FIG. 5 within the scope of the present disclosure.

Processor 510 performs computation and control functions of the smartphone 110. Processor 510 may include a single integrated circuit, such as a microprocessor, or may include any suitable number of integrated circuit devices and/or circuit boards working in cooperation to accomplish the functions of a processor or a CPU. The processor 510 is configured to execute one or more software programs contained in the memory 520.

The memory 520 includes:

determining instructions 522, for determining whether a private user allows a public account to acquire geographic location information of the private user when a conversation window between the private user and the public account is opened;

obtaining instructions 524, for obtaining the geographic location information of the private user if the private user allows the public account to acquire the geographic location information of the private user; and transmitting instructions 526, for transmitting the geographic location information of the private user to an IM server.

In one implementation, the memory 520 further involve instructions for determining whether the conversation window between the private user and the public account is opened for a first time; and notifying the IM server 160 that the conversation window is opened for the first time if the conversation window is opened for the first time, such that the IM server determines whether the public account has an ability of processing geographic location information.

In one implementation, the memory 520 further involve instructions for receiving from the IM server 160 a notification indicating that the public account has the ability of processing geographic location information to the private user before determining whether the private user allows the public account to acquire geographic location information of the private user; and receiving from the IM server a notification indicating that the public account does not have the ability of processing geographic location information to the private user.

The memory 520 may further store data and programs such as an operating system and one or more application programs.

Detailed functions of the smartphone 110 have been described above with reference to the method example and will not be repeated herein.

In various examples of the present disclosure, the geographic location information of the private user may be carried in a message 600.

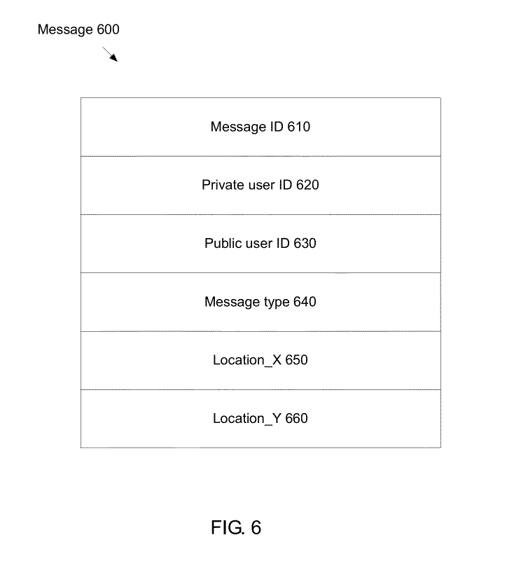

Referring now to FIG. 6, a block diagram of a message 600 in accordance with an example of the present disclosure is depicted. As shown in FIG. 6, the message 600 may include one or more of the following elements: a message ID 610, a private user ID 620, a public user ID 630, a message type 640, a location_X 650, and a location_Y 660.

The meaning of message ID 610, private user ID 620 and public user ID 630 are mostly self-explanatory. Location_X 650 and location_Y 660 denote longitude and latitude of the private user respectively. It should be noted that not all elements are mandatory and that default values may be applied for one or more message elements.

In various examples of the present invention, the IM application may include WeChat, QQ, ICQ, MSN Messenger, Skype, Fetion, AIM, GoogleTalk, MyspacelM, Sametime, Gadu Gadu, etc. Accordingly, the network computer system 100 may be a system implementing any one of the above listed IM applications.

As will be appreciated by one skilled in the art, aspects of the disclosed network computer system 100 disclosed herein may be embodied as a system, method or computer program product. Accordingly, aspects of the network computer system may take the form of an hardware embodiment, an software embodiment or an embodiment combining software and hardware aspects that may all generally be referred to herein as a “circuit”, “module” or “system”. Furthermore, aspects of the network computer system may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), a digital versatile disk (DVD), an erasable programmable read-only memory (EPROM or Flash memory), an optical fiber, a portable compact disc read-only memory (CD-ROM), an optical storage device, a magnetic storage device, or any tangible medium that can contain, or store a program for use by or in connection with an instruction execution system, apparatus, or device.

The figures are only illustrations of an example, wherein the modules or procedure shown in the figures are not necessarily essential for implementing the present disclosure. The modules in the aforesaid examples can be combined into one module or further divided into a plurality of sub-modules.

What is claimed is:

1. A computer-implemented method for obtaining geographic location information of a private user in instant messaging (IM), comprising:
when a conversation window between the private user and a public account is opened on a client device of the private user, determining, by the client device of the private user, whether the private user allows the public account to acquire geographic location information of the private user;
obtaining, by the client device of the private user, the geographic location information of the private user if the private user allows the public account to acquire the geographic location information of the private user; and
transmitting the geographic location information of the private user to an IM server, such that the IM server provides the geographic location information of the private user to the public account.

2. The computer-implemented method of claim 1, further comprising:
before determining whether the private user allows the public account to acquire the geographic location information of the private user, determining, by the client device of the private user, whether the conversation window between the private user and the public account is opened for a first time;
if the conversation window is opened for the first time, notifying, by the client device of the private user, the IM server that the conversation window is opened for the first time; and
performing the step of determining whether the private user allows the public account to acquire geographic location information of the private user after receiving a notification from the IM server indicating that the public account has an ability of processing geographic location information.

3. The computer-implemented method of claim 1, further comprising:
if the conversation window between the private user and the public account is opened for a first time, recording, by the client device of the private user, a status of authorization in the client device of the private user after determining whether the private user allows the public account to acquire the geographic location information of the private user, wherein the status of authorization indicates whether the private user allows the public account to acquire the geographic location information of the private user.

4. The computer-implemented method of claim 3, wherein the conversation window between the private user and the public account is opened for the first time, the determining whether the private user allows the public account to acquire geographic location information of the private user comprises:
displaying, by the client device of the private user, a prompt window to ask the private user whether the private user allows the public account to acquire the geographic location information of the private user; and
determining, by the client device of private user, whether the private user allows the public account to acquire the geographic location information of the private user according to a response of the private user;

5. The computer-implemented method of claim 3, wherein the conversation window between the private user and the public account is not opened for the first time, the determining whether the private user allows the public account to acquire geographic location information of the private user comprises:
determining, by the client device of the private user, whether the private user allows the public account to acquire the geographic location information of the private user according to the recorded status of authorization.

6. The computer-implemented method of claim 1, wherein the geographic location information of the private user is obtained and transmitted to the IM server periodically.

7. The computer-implemented method of claim 1, wherein the geographic location information of the private user is obtained using at least one of Wi-Fi, a cellular base station and Global Positioning System (GPS).

8. A computer-implemented method for obtaining geographic location information of a private user in instant messaging (IM), comprising:
receiving, by an IM server, geographic location information of a private user, wherein, when a conversation window is opened between the private user and a public user and if the private user allows the public user to acquire the geographic location information of the private user, the geographic location information of the private user is transmitted by a client device of the private user to the IM server; and
providing, by the IM server, the geographic location information of the private user to the public user.

9. The computer-implemented method of claim 8, further comprising:
receiving, by the IM server, from the client device of the private user a message indicating that the conversation window between the private user and the public account is opened for a first time; and
determining, by the IM server, whether the public account has an ability of processing geographic location information and notifying a determined result to client device of the private user.

10. A client device of a private user in instant messaging (IM), comprising a processor and a memory coupled to the processor, wherein the memory comprises machine readable instructions executable by the processor to:
determine whether a private user allows a public account to acquire geographic location information of the private user when a conversation window between the private user and the public account is opened;
obtain the geographic location information of the private user if the private user allows the public account to acquire the geographic location information of the private user; and
transmit the geographic location information of the private user to an IM server, such that the IM server provides the geographic location information of the private user to the public account.

11. The client device of claim 10, wherein the memory further comprises instructions executable by the processor to:
determine whether the conversation window between the private user and the public account is opened for a first time before determining whether the private user allows the public account to acquire the geographic location information of the private user;
notify the IM server that the conversation window is opened for the first time if the conversation window is opened for the first time; and
receive from the IM server a notification indicating that the public account has an ability of processing geographic location information.

12. The client device of claim 10, wherein the memory further comprises instructions executable by the processor to:
record, if the conversation window between the private user and the public account is opened for a first time, a status of authorization in the client device after determining whether the private user allows the public account to acquire the geographic location information of the private user, wherein the status of authorization indicates whether the private user allows the public account to acquire the geographic location information of the private user.

13. The client device of claim 12, wherein the memory further comprises instructions executable by the processor to:
if the conversation window between the private user and the public account is opened for the first time,
display a prompt window to ask the private user whether the private user allows the public account to acquire the geographic location information of the private user; and
determine whether the private user allows the public account to acquire the geographic location information of the private user according to a response of the private user;

14. The client device of claim 12, wherein the memory further comprises instructions executable by the processor to:
if the conversation window between the private user and the public account is not opened for the first time,
determine whether the private user allows the public account to acquire the geographic location information of the private user according to the recorded status of authorization.

15. The client device of claim 10, wherein the memory further comprises machine readable instructions executable by the processor to:
obtain the geographic location information of the private user using at least one of Wi-Fi, a cellular base station and Global Positioning System (GPS).

16. The client device of claim 10, wherein the memory further comprises instructions executable by the processor to:
obtain and transmit the geographic location information of the private user to the IM server periodically.

17. An IM server for obtaining geographic location information of a private user, comprising a processor and a memory coupled to the processor, wherein the memory comprises machine readable instructions executable by the processor to:
receive geographic location information of a private user, wherein when a conversation window is opened between the private user and a public user and if the private user allows the public user to acquire the geographic location information of the private user, the geographic location information of the private user is transmitted by a client device of the private user to the IM server; and
provide the geographic location information of the private user to the public user.

18. The IM server of claim 17, wherein the memory further comprises machine readable instructions executable by the processor to:
receive from the client device of the private user a message indicating that the conversation window between the private user and the public account is opened for a first time; and
determine whether the public account has an ability of processing geographic location information and notifying a determined result to client device of the private user.

19. A non-transitory computer readable storage medium storing one or more programs, which when executed by a processor, perform the steps of:
determining whether a private user allows a public account to acquire geographic location information of the private user when a conversation window between the private user and the public account is opened;
obtaining the geographic location information of the private user if the private user allows the public account to acquire the geographic location information of the private user; and
transmitting the geographic location information of the private user to an IM server, such that the IM server provides the geographic location information of the private user to the public account.

20. The non-transitory computer readable storage medium of claim 19, further comprising instructions for:
determining whether the conversation window between the private user and the public account is opened for a first time before determining whether the private user allows the public account to acquire the geographic location information of the private user;
notifying the IM server that the conversation window is opened for the first time if the conversation window is opened for the first time; and
receiving from the IM server a notification indicating that the public account has an ability of processing geographic location information.

21. The non-transitory computer readable storage medium of claim 19, further comprising instructions for:
recording, if the conversation window between the private user and the public account is opened for a first time, a status of authorization in the client device after determining whether the private user allows the public account to acquire the geographic location information of the private user, wherein the status of authorization indicates whether the private user allows the public account to acquire the geographic location information of the private user.

22. The non-transitory computer readable storage medium of claim 21, further comprising instructions for:
if the conversation window between the private user and the public account is opened for the first time,
displaying a prompt window to ask the private user whether the private user allows the public account to acquire the geographic location information of the private user; and
determining whether the private user allows the public account to acquire the geographic location information of the private user according to a response of the private user;

23. The non-transitory computer readable storage medium of claim 21, further comprising instructions for:
if the conversation window between the private user and the public account is not opened for the first time,
determining whether the private user allows the public account to acquire the geographic location information of the private user according to the recorded status of authorization.

24. A non-transitory computer readable storage medium storing one or more programs, which when executed by a processor, perform the steps of:
receiving geographic location information of a private user, wherein when a conversation window is opened between the private user and a public user and if the private user allows the public user to acquire the geographic location information of the private user, the geographic location information of the private user is transmitted by a client device of the private user; and
providing the geographic location information of the private user to the public user.

25. The non-transitory computer readable storage medium of claim 24, further comprising instructions for:
receiving from the client device of the private user a message indicating that the conversation window between the private user and the public account is opened for a first time; and
determining whether the public account has an ability of processing geographic location information and notifying a determined result to client device of the private user.
